(19) United States
(12) Patent Application Publication
(10) Pub. No.: US 2011/0016240 A1
(43) Pub. Date: Jan. 20, 2011

(54) Measuring and Analyzing Behavioral and Mood Characteristics in Order to Verify the Authenticity of Computer Users Works

(76) Inventors: Andrew Jesse Mills, Austin, TX (US); Shaun Sims, Austin, TX (US)

Correspondence Address: Andrew Mills, 3131 Castleleigh Rd, Silver Spring, MD, 20904, US

(21) Appl. No.: 12/835,734

(22) Filed: Jul. 13, 2010

Related U.S. Application Data
(60) Provisional application No. 61/225,553, filed on Jul. 14, 2009.

(51) Int. Cl. G06F 13/12; G06F 3/01; G09B 7/00

(52) U.S. Cl. 710/67; 715/733; 434/322

(57) ABSTRACT

Disclosed is a method of either verifying or rejecting the authenticity of a work submitted through use of a computer. This method involves examining the behavioral and mood biometric characteristics of the person(s) using the computer on which the work was created, while the work was being created. In a specific embodiment, this can be used to detect outsourcing and plagiarism in an online education class.

### CROSS-REFERENCE TO RELATED APPLICATIONS

This patent application claims the benefit of the filing date from Provisional Patent #61/225,553, entitled “Measuring and Analyzing Behavioral and Mood Characteristics in Online Education in Order to Verify the Authenticity of Students' Works.”

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

This invention relates to keystroke dynamics, specifically to an improved keystroke dynamics system that can authenticate and attribute a virtual body of work to a physical user.

2. Prior Art

Conventional keystroke dynamic technological implementation methods are used exclusively to verify the identity of a virtual user for various purposes by recording and analyzing the way that each user uniquely types. Originally, this technology was implemented only while a user types his or her login information in order to grant access to the appropriate user. This is accomplished in U.S. Pat. No. 4,805,222 to Young et al. (1989) by a user repeatedly typing a passphrase wherein the user trains the computer system to learn and recognize their unique typing pattern such that any unauthorized users' attempted login would be rejected. Improvements upon this system are shown in U.S. Pat. No. 7,509,686 to Checco (2009) and in the research paper “Keystroke Dynamics Based Authentication” published by Obaidat and Sadoun. These particular implementations are effective for security sensitive institutions such as online banking and security trading companies. However, this particular implementation is limited because it has no control over what happens after a user logs in. In other words, after an authorized user logs in an unauthorized user could take control of the system.

The technological implementation of keystroke dynamics has evolved to what Gunetti and Picardi at The University of Torino have termed “free text” keystroke dynamics in their paper, “Keystroke Analysis of Free Text”. This implementation is effective at identifying the user of a computer with public or multiple user access without requiring a user to repeatedly type a specific phrase or login and password. As stated in U.S. Pat. No. 7,260,837 to Abraham et al. (2007), marketing companies can use this technology to display relevant ads within a browser on a family computer by identifying which family member is using the computer at any given time. It is known that keystroke dynamics can be useful in a vague sense within an educational context by verifying the identity of students as briefly mentioned in “Keystroke Biometric Recognition on Long-Text Input: A Feasibility Study”. However, this paper reveals no method for authenticating a student's individual works in addition to their identity and therefore, merely states a market for which keystroke dynamics may be useful in its application.

All prior art suffers from a number of disadvantages, including:

A) The current prior art is only capable of producing an identity verification system in which a user's typing profile is collected to distinguish a user's identity from other users in the system. The prior art fails to reveal a system that solves the separate problem of attributing individual assignments or submissions comprising a larger body of works to a user in an educational context.

B) Additionally, there is an unfulfilled need in distance education courses to recognize if a student is copying a paper from another student or producing an original essay that reveals independent thought. No prior art reveals a system or method that can distinguish an original thought produced text output from a replicated text output.

C) Further, there is currently no prior art that reveals a method of analyzing a student's academic performance in an online course in correlation with an analysis of their keystroke dynamic samples in order to pinpoint additional evidence of cheating. For instance, if a student receives failing grades on every assignment up until the final examination for which he receives a perfect score, a correlative analysis of the student's typing patterns can potentially be especially revealing to the instructor.

D) There is no prior art that reveals a system in which a dynamic graphical user interface is connected to individual subsets of typing patterns composing a class such that user's with significant typing deviations are flagged for closer review by the administrator.

E) There is no prior art that reveals a system or method in which the administrator can adjust the level of tolerance the system has for each user.

### BACKGROUND OF THE INVENTION—OBJECTS AND ADVANTAGES

Accordingly, several objects and advantages of our invention are:

A) The current prior art is only capable of producing an identity verification system in which a user's typing profile is collected to distinguish a user's identity from other users in the system. Our invention reveals a system that solves the separate problem of attributing individual assignments or submissions comprising a larger body of works to a user in an educational context.

B) Our invention marks a much needed and neglected improvement in keystroke dynamic technological implementation in an educational context comprising a situation in which a logged in user needs to have not only his identity verified throughout a log in session but to additionally have each individually submitted assignment or piece of work authenticated and attributed to him or her. This extends beyond situations in which one assignment is completed per login session to cases where one assignment is completed across multiple login sessions or, oppositely, multiple assignments are completed within one log in session.

C) Our invention reveals a method of analyzing a student's academic performance in an online course in correlation with an analysis of their keystroke dynamic samples in order to pinpoint additional evidence of cheating. For instance, if a student receives failing grades on every assignment up until the final examination for which he receives a perfect score, a correlative analysis of the student's typing patterns can potentially be especially revealing to the instructor.

D) Our invention reveals a system in which a dynamic graphical user interface is connected to individual subsets of typing patterns composing a class such that users with significant typing deviations are flagged for closer review by the administrator.

E) Our invention reveals a system or method in which the administrator can adjust the level of tolerance the system has for each user.

### BRIEF SUMMARY OF THE INVENTION

The present invention is a method of collecting users' behavioral and mood biometric characteristics when they interact with a computer and performing a similarity calculation of these characteristics.

### DRAWINGS

Not Applicable

### DETAILED DESCRIPTION OF THE INVENTION

For the purposes of this patent, we take the term “behavioral biometrics” to mean ingrained patterns of a person's actions that are highly distinct for each person. In other literature, some behavioral biometrics found have been how long each key is held down (a dwell time), how long it takes to transition from one key to another (a transition time), how long it takes to transition from one key to another key n keys later (an “n+l” graph), and how much pressure a key is struck with. However, our invention is not limited to these behavioral biometrics named.

We take the term “mood biometrics” to mean patterns of a person's actions that are highly distinct to the state of mind of said person while performing said actions. For example, a person may be in a state of mind of original thought or a state of mind of transcribing someone else's work. In our research and experimentation, we have found transition times greater than a certain threshold to be a mood biometric. An intuitive explanation of this is that below that threshold, transition times are mechanical reflexes and so are a behavioral biometric, but larger transition times represent momentary pauses of a user stopping to think. These pauses are like a window into a user's mind. Our invention is not limited to this mood biometric only.

“Characteristics” are the specific measurements of users' actions that capture aspects of behavioral and mood biometrics. We have given several examples already.

“Session” means a relatively continuous period of time in which a user is using a computer for a particular activity. For more clarity, a session need not be inside of a login session, and a login session may contain one or more sessions (as the user may work on more than one different activity while logged in).

Our method proceeds as follows. First, we record every keystroke and the timing of every keystroke a user types on his/her keyboard while logged in to and interacting with a local or remote system. Optionally, we may record every action a user makes on a computer peripheral (such as a mouse or other pointing device or a game controller) while logged in to and interacting with said system. An algorithm is run that, for each user, aggregates the collected data (from the keyboard and optionally, peripherals) of one or more sessions for each user so that the behavioral and mood biometric characteristics witnessed while each unit of work was being produced are grouped. Next, we compare the collected data of a unit of work purportedly created by a specific user to the collected data from other units of work by said user and the collected data from other units of work by other users. We perform mathematics to compare how similar different data samples are. As preferred embodiments, this mathematics may involve neural nets or statistics. The mathematics may also incorporate the grade the instructor assigns to the students' assignments. An abnormally high grade coupled with an uncharacteristic typing pattern for one assignment may be cause for suspicion. The mathematics may also incorporate the frequency and pattern that each user switches between windows or alters his/her viewable area associated with the login session on their computer's graphical user interface. An abnormally high number of window switches may imply the computer's user is using another program running on that computer to assist them in their work. The system then outputs judgments on the likelihood that said unit of work was authentically created by said user and/or that said unit of work was independently produced by said user and not transcribed from an outside aid.

### CONCLUSIONS, RAMIFICATIONS, AND SCOPE

The invention presented here is the first to fully harness the power of keystroke dynamics. In so doing, it solves a crucial problem for, for instance, online education.

Much of the preceding discussion has centered on students completing work for online classes, but it is easy to see that our invention is more general than that and works in many other contexts.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A method comprising:
a. recording keystrokes and the timing of keystrokes a user types on his/her keyboard while interacting with a local or remote system;
b. aggregating the collected data of part a of one or more of said user's sessions so that the behavioral biometric characteristics witnessed while each unit of work was being produced are grouped;
c. performing mathematics to compare how similar the collected data of part b from a particular unit of work is from other units of work purportedly created by said user; and
d. using the results of part c to output a judgment on the likelihood that said unit of work was authentically created by said user.

2. The method of 1 used in the context of online education.

3. The method of 1 used in the context of online multi-user video games.

4. The method of 1 further comprising collecting additional distinguishing indicators about users' activities and incorporating them into the similarity calculation of part 1c.

5. The method of 4 wherein the collection of said additional distinguishing indicators includes recording actions a user makes on a computer peripheral, such as a mouse or other pointing device or a game controller, while interacting with said system.

6. The method of 5 used in the context of online multi-user video games.

7. The method of 1 further comprising incorporating into the mathematical analysis of part 1c an evaluation of said user's performance in completing said unit of work.

8. The method of 7 in an educational context, wherein said user's performance is a grade assigned to them by an instructor.

9. The method of 1, further comprising:
a. additionally collecting the frequency and pattern that each user switches between windows or alters his/her viewable area associated with the session on their computer's graphical user interface; and
b. additionally incorporating into the mathematical analysis of part 1c the data collected from part 9a.

10. The method of 9 used in the context of online education.

11. The method of 1 further comprising considering the collected data from other units of work by other users in the mathematical analysis of part 1c.

12. The method of 11 used in the context of online education.

13. The method of 1 whereby the mathematical analysis is rerun at periodic intervals based on updated data.

14. The method of 13 used in the context of online education.

15. The method of 1 wherein the user is not using a traditional desktop or laptop computer but another type of electronic device.

16. A method comprising:
a. recording keystrokes and the timing of keystrokes a user types on his/her keyboard while interacting with a local or remote system;
b. aggregating the collected data of part a of one or more of said user's sessions so that the behavioral biometric characteristics witnessed while each unit of work was being produced are grouped;
c. performing mathematics to compare how similar the collected data of part b from a particular unit of work is from other units of work purportedly created by said user; and
d. using the results of part c to output a judgment on the likelihood that said unit of work was independent created by said user and not transcribed from an outside aid.

17. The method of 16 used in the context of online education.

18. The method of 16 used in the context of online multi-user video games.

19. The method of 16 further comprising collecting additional distinguishing indicators about users' activities and incorporating them into the similarity calculation of part 16c.

20. The method of 16 wherein the collection of said additional distinguishing indicators includes recording actions a user makes on a computer peripheral, such as a mouse or other pointing device or a game controller, while interacting with said system.

21. The method of 20 used in the context of online multi-user video games.

22. The method of 16 further comprising incorporating into the mathematical analysis of part 16c an evaluation of said user's performance in completing said unit of work.

23. The method of 22 in an educational context, wherein said user's performance is a grade assigned to them by an instructor.

24. The method of 16, further comprising:
a. additionally collecting the frequency and pattern that each user switches between windows or alters his/her viewable area associated with the session on their computer's graphical user interface; and
b. additionally incorporating into the mathematical analysis of part 15c the data collected from part 24a.

25. The method of 24 used in the context of online education.

26. The method of 16 further comprising considering the collected data from other units of work by other users in the mathematical analysis of part 16c.

27. The method of 26 used in the context of online education.

28. The method of 16 whereby the mathematical analysis is rerun at periodic intervals based on updated data.

29. The method of 28 used in the context of online education.

30. The method of 16 wherein the user is not using a traditional desktop or laptop computer but another type of electronic device.
